(19) United States
(12) Patent Application Publication
(10) Pub. No.: US 2024/0078380 A1
(43) Pub. Date: Mar. 7, 2024

(54) Framework for Evaluation of Document Summarization Models

(71) Applicant: ServiceNow, Inc., Santa Clara, CA (US)

(72) Inventors: Sathwik Tejaswi Madhusudhan, Santa Clara, CA (US); Anirudh Sreeram, Santa Clara, CA (US)

(21) Appl. No.: 17/903,361

(22) Filed: Sep. 6, 2022

(51) Int. Cl. G06F 40/216; G06F 40/279

(52) U.S. Cl. CPC G06F 40/216; G06F 40/279

(57) ABSTRACT

Persistent storage contains an original document and a plurality of summaries of the original document produced by summarization models. One or more processors: provide, to an entity extractor, the original document; receive, from the entity extractor, a list of entities within the original document; provide, to a query generator, the original document and the list of entities; receive, from the query generator, a set of queries answerable by the original document; provide, to a query answerer, the set of queries, the original document, and the plurality of summaries; receive, from the query answerer and for the set of queries, a set of document answers corresponding to the original document and sets of summary answers corresponding to the plurality of summaries; provide, to an answer matcher, the set of document answers and the sets of summary answers; and receive, from the answer matcher, scores for the plurality of summaries.

### BACKGROUND

Document summarization involves condensing the text of a larger, original document into a shorter summary thereof. A goal of this task is to represent key information from the original document in the shorter summary while maintaining the semantic context of the original document. As the amount of textual data that is used in public and private settings has exploded in recent years, accurate and efficient document summarization is now more important than ever before. Numerous automated document summarization techniques exist, typically based on natural language processing and/or various types of machine learning models. But, the effectiveness of these models (i.e., the quality of the summaries that they produce) can vary dramatically.

### SUMMARY

The embodiments herein address these and other technical limitations of the state of the art by providing an improved framework for evaluating document summarization techniques. Among other aspects, this improved framework generates queries from entities extracted from an original document, and attempts to answer these queries based on the original document as well as each of one or more summaries generated by different summarization techniques. Comparisons between the respective answers to these queries can be scored to represent the quality of each of the summaries. When performed over a large enough corpus of original documents, the scores provide an accurate representation of the respective accuracy of each summarization technique.

Accordingly, a first example embodiment may involve persistent storage containing: (i) an original document, and (ii) a plurality of summaries of the original document respectively produced by a plurality of summarization models, wherein the original document and each of the plurality of summaries include textual content. The first example embodiment may also involve one or more processors configured to: provide, to an entity extractor application, the original document; receive, from the entity extractor application, a list of entities found within the textual content of the original document; provide, to a query generator application, the original document and the list of entities; receive, from the query generator application, a set of queries answerable by the textual content of the original document, wherein the set of queries is based on the list of entities; provide, to a query answering application, the set of queries, the original document, and the plurality of summaries; receive, from the query answering application and for the set of queries, a set of document answers corresponding to the original document and sets of summary answers respectively corresponding to each of the plurality of summaries; provide, to an answer matching application, the set of document answers and the sets of summary answers; and receive, from the answer matching application, respective scores for each of the plurality of summaries, wherein the respective scores represent accuracies of the sets of summary answers with respect to the set of document answers.

A second example embodiment may involve providing, to an entity extractor application, an original document, wherein the original document includes textual content; receiving, from the entity extractor application, a list of entities found within the textual content of the original document; providing, to a query generator application, the original document and the list of entities; receiving, from the query generator application, a set of queries answerable by the textual content of the original document, wherein the set of queries is based on the list of entities; providing, to a query answering application, the set of queries, the original document, and a plurality of summaries of the original document, wherein the plurality of summaries were respectively produced by a plurality of summarization models, and wherein each of the plurality of summaries also includes textual content; receiving, from the query answering application and for the set of queries, a set of document answers corresponding to the original document and sets of summary answers respectively corresponding to each of the plurality of summaries; providing, to an answer matching application, the set of document answers and the sets of summary answers; and receiving, from the answer matching application, respective scores for each of the plurality of summaries, wherein the respective scores represent accuracies of the sets of summary answers with respect to the set of document answers.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an original document and a corresponding summary, in accordance with example embodiments.

FIG. 7 is a flow chart, in accordance with example embodiments.

FIG. 8 is a flow chart, in accordance with example embodiments.

FIG. 9 depicts a dependency graph, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

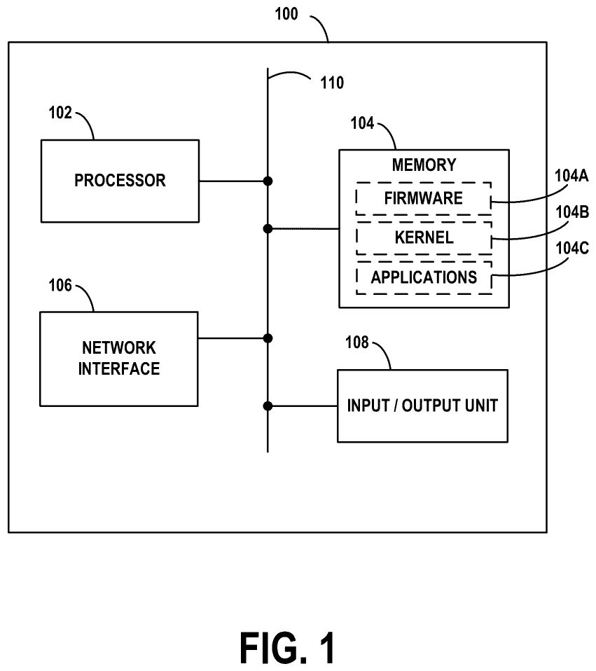

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

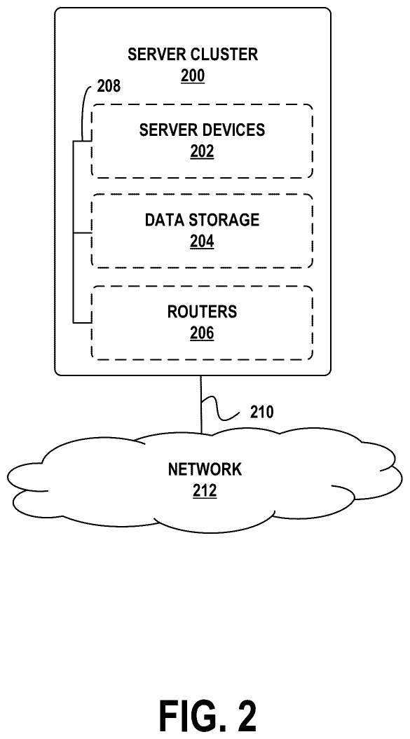

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

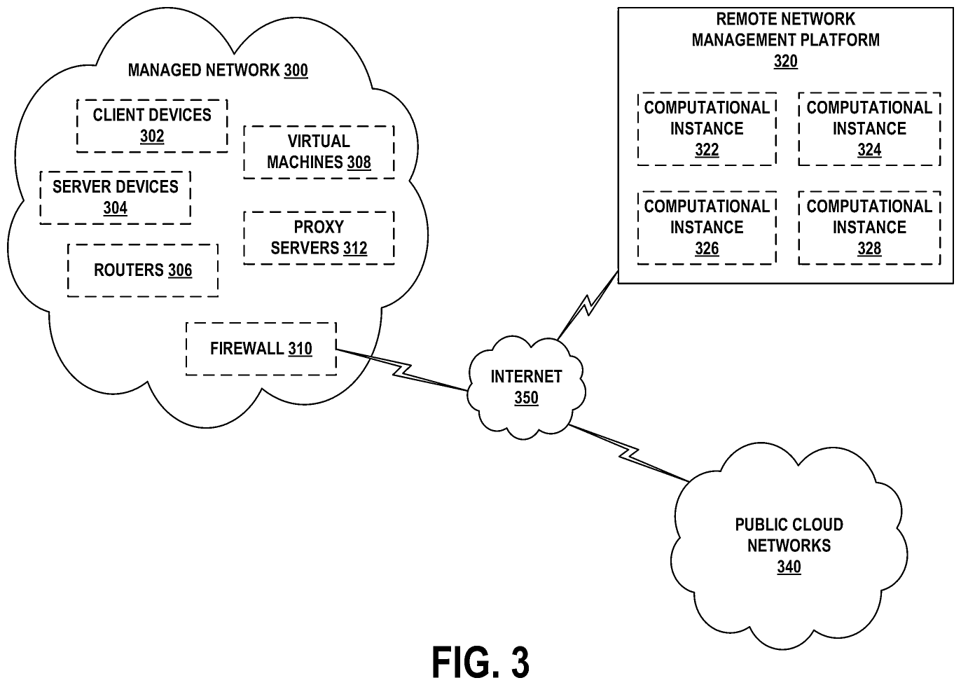

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

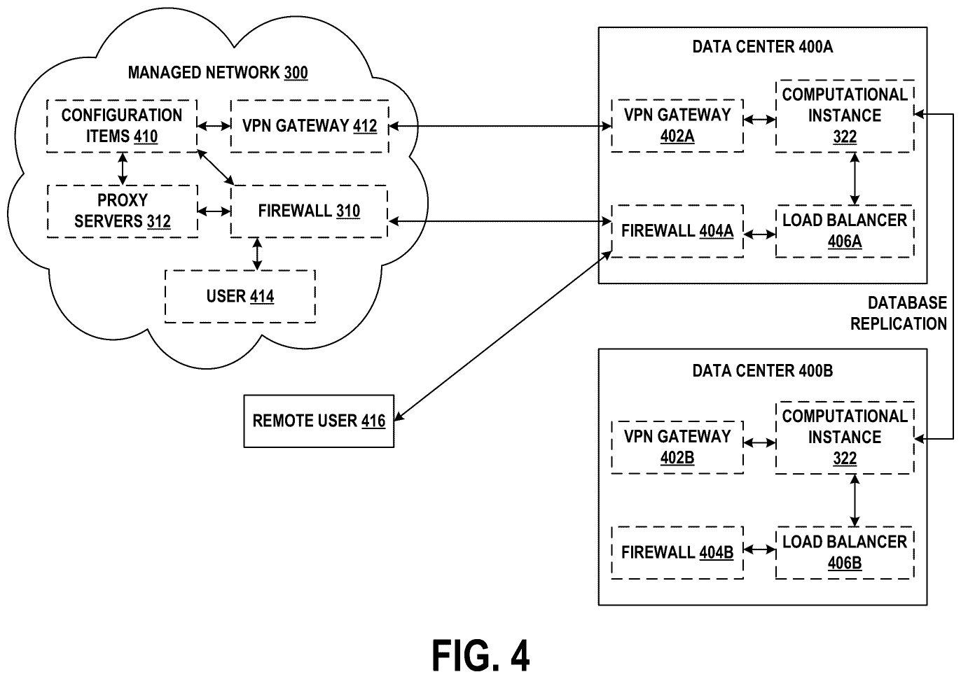

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

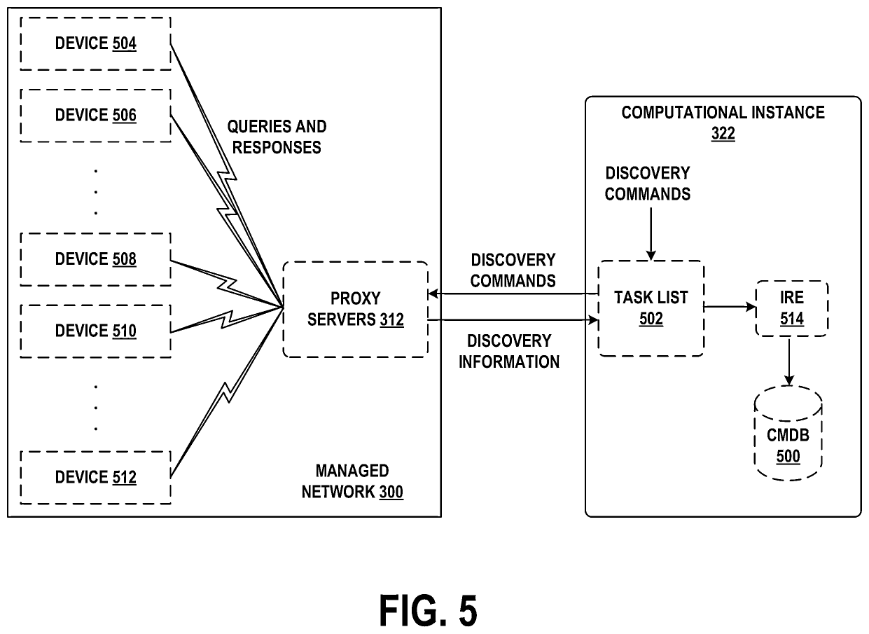

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Document Summarization and Evaluation Thereof

Accurate document summarization is becoming a critical feature of computing systems that store, retrieve, and/or otherwise manage large numbers of documents. For example, a remote network management platform (e.g., remote network management platform 320) may include a number of databases containing thousands or millions of text-based records. Some of these records may be quite lengthy (e.g., knowledgebase articles, IT incident records, email threads, etc.). Further, these databases may be frequently searched, with search results being provided to the requesting user or application.

If accurate summaries of the original documents are provided, the search application can operate on the shorter summaries rather than the larger documents, thus reducing the amount of computing resources (e.g., processing and memory resources) used for searching. Further, accurate summaries would allow requesting users to be able to determine whether a document is relevant to their needs just by reading its summary rather than the larger document.

The desirability of accurate document summarization techniques exists in a wide number of additional industries, such as medicine (summarization of electronic health records), pharmaceuticals (summarization of drug safety reports), academia (summarization of research papers), and so on. Thus, the embodiments herein have a wide scope, though they can be tailored to specific use cases and specific user requirements.

A number of automated summarization models exist. Typically based on various types of natural language processing and/or machine learning techniques, these models generally fall into two categories, extractive and abstractive.

Extractive models evaluate and select sentences from an original document to include in its summary. For example, an extractive model may first construct an intermediate representation of the text within the original document based on term frequency metrics, word positons, and possibly other statistical characteristics of the text. Then, the extractive model may score each sentence in the text based on its predicted importance. The sentences with the top k scores are selected for the summary, where k can be fixed value or a user-configurable parameter. In some cases, latent sentiment analysis may be employed to identify semantically important sentences in this last step. Other extractive summarization models are based on trained neural networks and/or word vectors (where words are projected into a semantically-relevant m-dimensional space such that words with similar meanings are closer to one another in the m-dimensional space than words with less similar meanings).

In the embodiments herein, the degree of similarity between two units of text can be determined by calculating a similarity measurement between their respective vector representations. One such measurement may be based on cosine similarity, which is defined by the following equations:

$$similarity ( \vec{A} , \vec{B} ) = \frac{\vec{A} \cdot \vec{B}}{‖ \vec{A} ‖ ‖ \vec{B} ‖}$$

$$where ‖ \vec{A} ‖ = \sqrt{{A}_{1}^{2} + {A}_{2}^{2} + {A}_{3}^{2} + ⋯ + {A}_{m}^{2}} , and$$

$$‖ \vec{B} ‖ = \sqrt{{B}_{1}^{2} + {B}_{2}^{2} + {B}_{3}^{2} + ⋯ + {B}_{m}^{2}}$$

In these equations, vector A could represent one input vector and vector B could represent another input vector, each of which could be derived from units of text, for example. Vector A and vector B could both be of dimension m. The similarity calculation may have an output a number between −1.0 and +1.0, where the closer this result is to +1.0, the more similar vectors A and B are to each other.

Alternatively, recall-oriented understudy for gisting evaluation (ROUGE) scores, ROUGE-based scores, or comparable techniques could be used to determine the similarity of texts on an n-gram basis. Generally, speaking, the greater the overlap of n-grams between two documents and/or summaries, the greater the similarity of these documents and/or summaries.

Abstractive models typically employ deep learning techniques (e.g., large-scale neural networks) to produce summaries using generated sentences. The models aim to generalize these sentences based on the semantic content of the original document, but may use words and/or phrase that do not appear in the original document. For example, an encoder portion of a neural network may encode the original document into a vector representation, and then a decoder portion of the neural network may decode the vector representation into the summary. Other abstractive models may employ an attention mechanism (focusing on a few modules of a neural network while largely ignoring others), which has recently been shown to outperform generic neural networks on certain natural language processing tasks.

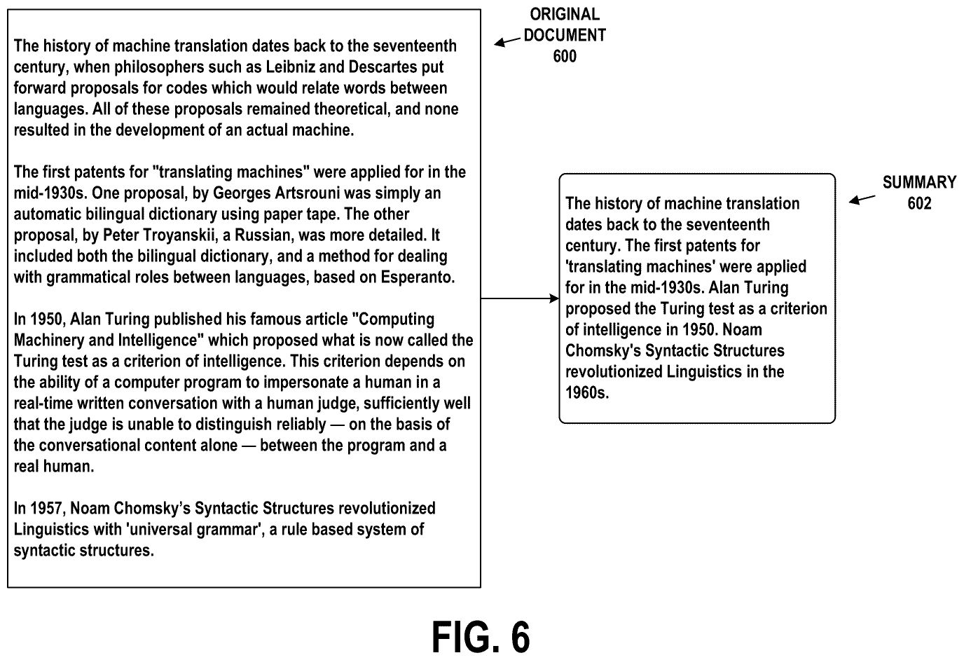

FIG. 6 depicts an example original document 600 and a corresponding example summary 602. Summary 602 was generated by a hybrid extractive/abstractive model. Some sentences in summary 602 are copied directed from original document 600 (e.g., “The history of machine translation dates back to the seventeenth century.”) while another is a rewording of text from original document 600 (i.e., “Alan Turing proposed the Turing test as a criterion of intelligence in 1950.”), and yet another contains what appears to be an inferential error (i.e., “Noam Chomsky's Syntactic Structures revolutionized Linguistics in the 1960s.”).

While extractive models are simpler to implement, they are unable to paraphrase or generalize words or phrases appearing in the original document. Abstractive models promise greater accuracy but are much more complex. Further, natural language processing is not perfect (as shown in FIG. 6), and therefore both types of models sometimes fail in spectacular or embarrassing ways. Moreover, some summarization models may produce high-quality summaries for original documents with one type of content (e.g., IT incident) but product low-quality summaries for original documents with another type of content (e.g., electronic health records).

As a consequence, it is desirable to be able to evaluate the accuracy of one or more summarization models before deploying these models in a production environment. But current evaluation frameworks are limited and often lack the ability to clearly differentiate between high quality and low quality summaries.

Such evaluation frameworks may be based on scoring the summaries with respect to their original documents in terms of n-gram co-occurrences. But these frameworks do not account for summary readability, and are biased against abstractive summarization techniques that may produce summaries with fewer n-grams in common with the original document that extractive techniques. Other frameworks are based on query-answering metrics, where it is presumed that a high-quality summary would be able to answer (e.g., inform the reader) most of the same queries that the original document can answer. These frameworks tend to work better with abstractive models.

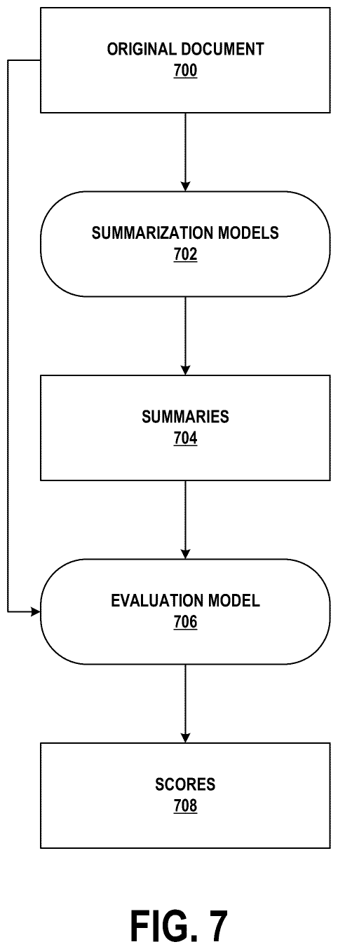

FIG. 7 provides an example of an evaluation framework. In FIG. 7, data is generally represent by rectangular blocks while program logic is generally represented by blocks with rounded edges unless context suggests otherwise.

Original document 700 may be a unit of text, such as an article, an IT incident, an email thread, or some other type of information. Summarization models 702 may be one or more individual summarization models (e.g., extractive, abstractive, or hybrid) that may operate based on different natural language processing techniques. Each of summarization models 702 may read original document 700 and produce a respective summary, collectively represented by summaries 704. Summaries 704 may be shorter versions of original document 700 and may be stored in short-term or long-term memory. Evaluation model 706 may read original document 700 and summaries 704, and then produce scores 708. Evaluation model 706 may do so by comparing semantic characteristics of original document 700 with each of summaries. Scores 708 may be, for example, on a scale of 0-100 with higher scores indicative of better summaries. Thus, there may be j summarization models, j summaries, and j scores.

Normally, the summary with the highest score would be selected for use in a production environment. When summarization models 702 are being evaluated, then this framework may be applied to a corpus of original documents (e.g., several hundred, several thousand, or more), and the model that produces summaries with the highest average score would be selected for production use. Alternatively, a weighted average could be used, with the weighting reflecting the relative importance of the original document.

Nonetheless, it has been found that existing frameworks do not perform as well as the research has suggested. Like the summarization models, in evaluation frameworks overall quality can be content-specific and is heavily based on the nature and scope of the queries that are provided as input. For example, suppose that an original document contains a general topic and three specific sub-topics. An end user may be primarily interested in one of these sub-topics. While the summary produced by a summarization model might omit or gloss over this sub-topic of interest, an evaluation framework might still score the summary as being high quality. Thus, there is a need for improved evaluation frameworks in general, as well as ones that can be tuned to evaluate summaries based on specific interests of users.

### VII. Improved Summary Evaluation Framework

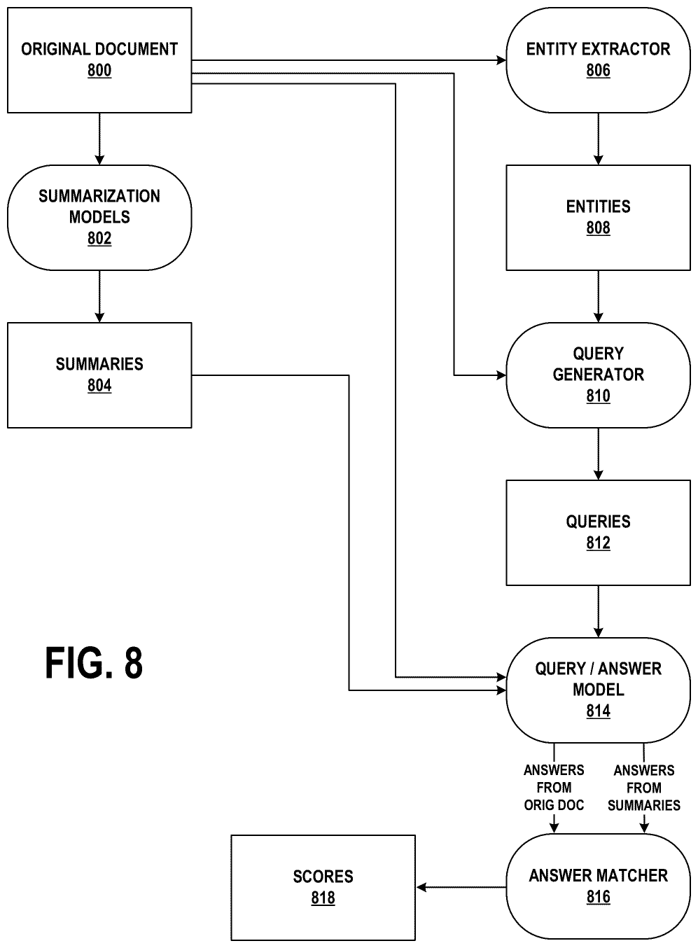

FIG. 8 depicts an improved evaluation framework for automatically generated summaries. This framework can operate on any type of generated summary, whether extractive, abstractive, or a hybrid of extractive and abstractive techniques. Further, this framework can also be used to evaluate human generated summaries as well. Like FIG. 7, in FIG. 8 data is generally represent by rectangular blocks while program logic is generally represented by blocks with rounded edges unless context suggests otherwise. Each unit of program logic may be implemented in the form of one or more executable applications or application libraries.

While human generated summaries are too subjective and resource intensive for production use, they can be used as a baseline for quality comparison with automatically generated summaries. For example, a human generated summary might be considered to have an acceptable level of quality, and automatically generated summaries for the same original document with qualities that approach or exceed that of a human generated summary may be deemed to also have an acceptable level of quality.

Original document 800, summarization models 802, and summaries 804 are respectively analogous to original document 700, summarization models 702, and summaries 704. Thus, original document 800 may be a unit of text, such as an article, an IT incident, an email thread, or some other type of information. Summarization models 802 may be one or more individual summarization models (e.g., extractive, abstractive, or hybrid) that may operate based on different natural language processing techniques. Each of summarization models 802 may read original document 800 and produce a respective summary, collectively represented by summaries 804. Summaries 804 may be shorter versions of original document 800 and may be stored in short-term or long-term memory.

In order to more accurately evaluate the efficacy of summarization models 802, blocks 806-818 may be employed. These blocks entail the core of the improved framework.

Entity extractor 806 obtains, from original document 800 and/or based on its textual content, key words and/or phrases that are likely to have the greatest influence on or represent the semantic meaning of this document. Several possible techniques for this extraction are possible.

One technique is named entity recognition (NER), which uses grammar recognition, a database, and/or machine learning techniques to associate words and/or phrases in an original document with the types and/or characteristics thereof. As an example, NER applied to original document 600 might determine that “Leibniz”, “Descartes”, “Georges Artsrouni”, “Peter Troyanskii”, “Alan Turing”, and “Noam Chomsky” are all people. NER might also determine that “the 1930s”, “1950”, and “1957” are years. Other types of entities may be recognized as well.

Another technique for entity extraction could be based on regular expressions. Regular expressions are shorthand sequences of characters that represent types of patterns that could be found in an original document. In some cases, regular expressions can be used to efficiently identify phone numbers, email addresses, postal addresses, incident numbers, and so on. For example, the regular expression “/\hat{ }[12][0-9]{3}$/” can be used to identify any 4-digit year between 1000 and 2999. Applied to original document 600, such a regular expression would classify “1930”, “1950”, and “1957” as years.

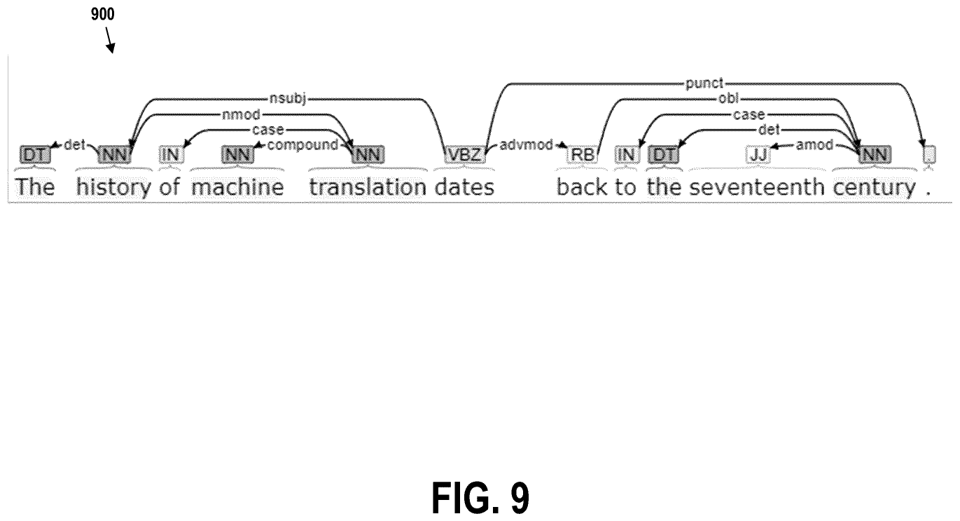

Yet another technique for entity extraction is based on dependency parsing. This technique creates trees or graphs that represent the dependencies between words in an original document. For example, the words may be mapped to parts of speech (e.g., determiners, subjects, verbs, objects, modifiers, etc.), and dependencies are found based on syntactic relationships between these parts of speech. An example of dependency parsing applied to the sentence “The history of machine translation dates back to the seventeenth century.” from original document 600 may result in graph 900 shown in FIG. 9. In graph 900, nodes labeled “DET” are determiners, nodes labeled “NN” are nouns, nodes labeled “VBZ” are verbs, and so on. These dependencies are particular useful when generating queries based on the text of original document 800 (see below).

Entity extractor 806 may employ any one or more of NER, regular expressions, and/or dependency parsing to obtain entities 808 from original document 800. Entities 808 may be stored in short-term or long-term memory. Nonetheless, other techniques may be used.

Based on entities 808, query generator 810 may generate a set of queries from the text of original document 800. Each of these queries should be related to at least one of entities 808 and answerable from information within an original document. For example, given the passage “The history of machine translation dates back to the seventeenth century.” in original document 600, a relevant query might be “To when does machine translation date back?” Thus, queries can be generated by rearranging declarative sentences within an original document into query form. Other query generation techniques employ rule-based algorithms, expert systems, and/or encoder-decoder neural network architectures. The latter may take a passage (possibly multiple sentences) as input, encode this passage to a semantically encoded m-dimensional vector, and then decode the vector into a semantically relevant query. Other techniques are possible, such as using attention and/or transformer models.

Regardless of implementations, query generator 810 may produce one or more queries 812 from original document 800. Queries 812 may be stored in short-term or long-term memory. In some embodiments, user-generated queries (not shown in FIG. 8) may be added to queries 812, possibly replacing some or all of those that were produced by query generator 810.

User-generated queries modify the evaluation of summarization models 802 in a manner that focuses on information that is relevant to the user or users providing the user-generated queries. Providing user-generated queries are particular important in certain fields or domains where a user might want to use a summarization model that is likely to include the relevant information in its summary.

For example, in the medical field, a medical professional (e.g., a doctor or researcher) might want to use a summarization model on a corpus of electronic health records that is going to produce summaries including each patient's blood pressure readings and whether they are on certain medications. Thus, the medical professional might provide user-generated queries such as “What is the patient's blood pressure?” and “What are the patient's medications?” Or, if the medical profession is mainly interested in patients taking Lisinopril / Hydrochlorothiazide (a frequently-prescribed combination of drugs for lowering blood pressure), the medical professional might provide a user-generated query such as “Is the patient on Lisinopril/Hydrochlorothiazide?”

Alternatively, the user might instead provide one or more topics, and queries 812 might be filtered based on these topics. For example, the user (again assuming a medical professional) might provide the topics “blood pressure” and “medications”, and then each of queries 812 is classified (e.g., using natural language processing techniques such as similarity analysis or semantic intent prediction) as to whether that query is related to at least one of the topics. If not, the query is filtered out of queries 812. Alternatively, the topics could be provided to query generator 810 so that queries 812 are more likely to be related to the topics. For example, query generator 810 might specifically search original document 800 and/or entities 808 for the topics (and/or similar or analogous topics) and generate queries from any passages in original document 800 that are sufficiently similar (e.g., a similarity metric above a threshold value—for the cosine similar metric above, this could be 0.5, 0.7, 0.8, etc.).

Since electronic health records contain information relating to many different aspects of a patient's health, introduction of user-generated queries can result in those of summarization models 802 that produce answers to these queries having a higher score than those that do not.

To that point, query/answer model 814 (a query answering application) takes queries 812 and tries to answer these queries from original document 800 as well as from each of summaries 804. Thus, if there are j summaries, there will be j+1 sets of answers. To do so, query/answer model 814 may employ the attention mechanisms described above, perhaps in combination with a recurrent neural network (e.g., using a long short-term memory model), or a transformer (e.g., based on bidirectional encoder representations from transformers) that uses sentiment analysis on queries to process each word of a query in the context of the other words in the query. Similar sentiment analysis may be performed on the original document and the plurality of summaries.

Regardless, once the intent of the query is represented (e.g., as a vector), this representation is compared to the text in order to find possible answers. Query/answer model 814 may be trained to select an answer that it predicts to be most relevant if multiple answers are provided. After determination of the answers from original document 800 and each of summaries 804, these answers are provided to answer matcher 816.

TABLE 1
Queries and associated answers

| | Answer from Original | Answer from | Answer from Additional |
|---|---|---|---|
| Query | Document 600 | Summary 602 | Summary |
| Q1: “To when does machine | The seventeenth century | The seventeenth | When proposals for codes |
| translation date back?” | | century | |
| Q2: When did Noam Chomsky | 1957 | 1960s | 1957 |
| revolutionize linguistics? | | | |
| Q3: Was Troyanskii's dictionary | Yes | N/A | N/A |
| based on Esperanto? | | | |
| Q4: What was proposed by Alan | The Turing test | Turing test | Famous article |
| Turing | | | |

| | | |
|---|---|---|
| Scores | 2/4 = 50% | 1/4 = 25% |

Answer matcher 816 may score the performance of each of the summaries in terms of how closely their answers match those of the original document. Table 1 provides an example, of a set of queries and associated answers produced by query answer model from original document 600, summary 602, and a hypothetical additional summary (not shown in the figures).

As shown in Table 1, summary 602 provided an answer that matches that of original document 600 for Q1, but the additional summary did not. Therefore, answer matcher 816 concludes that summary 602 answered this query correctly, while the additional summary did not. Conversely, answer matcher 816 would conclude that summary 602 answered Q2 incorrectly and that the additional summary answered this query correctly. For Q3, neither summary was able to answer a yes/no query about the content of original document 600. For Q4, answer matcher 816 concludes that summary 602 answered this query correctly (as it substantively but not exactly matches the answer from original document 600), while the additional summary did not.

The scores provided at the bottom of Table 1 for each summary is a simple percentage of how many queries of the set were answered correctly by each summary. Thus, summary 602 obtained a score of 50% and the additional summary obtained a score of 25%. Based on these criteria, summary 602 would be considered to be “superior” to the additional summary. Of course, a more comprehensive evaluation may entail a larger number of queries and a baseline score (e.g., 50%, 70%, 80%) below which summaries are considered to be too inaccurate for their corresponding summarization models to be recommended for production use.

The resulting scores 818 may be saved in short-term or long-term memory. From scores 818, one of summarization models 802 may be selected. For example, the process of FIG. 8 may be carried out for a corpus of original documents (e.g., several hundred, several thousand, or more) and the summarization model that produces summaries with the highest average score may be selected. The selected summarization model may then be used to generate summaries of a set of original documents (either the corpus used for evaluation, a different corpus, or a combination thereof), with these summaries being provided for production use.

Such production use may be within the context of a computational instance of remote network management platform 320. Thus, the selected summarization model may generate summaries of knowledgebase articles, IT incidents, and/or email threads. Such summaries may be provided as first results to users who search associated databases (e.g., by way of a web-based interface or a mobile application). If the user is interested in a summary, the user may click through or otherwise select the summary, and the corresponding original document may be retrieved and presented to the user.

Nonetheless other uses are possible. And as noted above, the evaluation framework provided herein is not limited to information related to or stored within a remote network management platform, and could be used on other types of platforms and with other types of applications.

An additional technique (not shown in the figures) for evaluating the quality of generated summaries can be based on entity overlap between the original document and the summaries. As noted above, some summarization models (those that are abstractive in particular) can sometimes generate summaries containing nonsense or information that is not in the original document.

To determine whether this is happening, the original document and a generated summary are both provided entity extractor 806. Thus, two lists of extracted entities are produced, one from the original document and another from the summary. The list of entities from the original document should be longer than the list from the summary (e.g., 100 entities extracted from the original document and 20 from the summary). Ideally, each entity found in the summary would also be found in the original document. If not, then the summarization model that generated the summary produced an error.

When the entities from the summary are a subset of the entities from the original document, then a further test may determine whether queries related to each of the entities from the summary are present in and/or can be answered correctly by the original document. If so, then the summarization model is producing a summary including correct entities in the correct context (i.e., the same context as that of the original document). Otherwise, the summarization model is producing a summary using at least some correct entities in an incorrect context.

Thus, summarization models that tend to produce summaries including correct entities in the correct context are preferred over summarization models that tend to produce summaries including correct entities in an incorrect context. Further, both of these types of summarization models are preferred over those that produce summaries including incorrect entities.

### VIII. Evaluating the Evaluation Frameworks

Given the embodiments herein and prior evaluation frameworks, it is desirable to know whether the evaluation framework described in the context of FIG. 8 outperforms the other frameworks. Or, more generally, given an evaluation framework and a set of summarization models, can the evaluation framework pick a “good” or “the best” summarization model? Further how much can the evaluation framework differentiate between summarization models in terms of their scores? For example, an evaluation framework that clusters all scores within a narrow range of values is likely to be less accurate than an evaluation framework that spreads these scores out over a broader range of values (and is thus better able to distinguish between summarization models).

To answer the first question with respect to the embodiments herein, a test similar to the Turing test was performed. In this test, a human-generated summary of an original document was used in conjunction with four summaries of the same original document that were generated by different summarization models. These five summaries were given to each of several candidate evaluation frameworks, including the evaluation framework of FIG. 8. The five summaries were also given to a human. The evaluation frameworks and the human were each tasked with selecting the summarization model that produced the best summary. This was repeated for 300 documents.

The evaluation framework of FIG. 8 was shown to select the same summarization model as that of the human more frequently than any other evaluation framework tested. Thus, this indicates that the embodiments herein have a higher degree of efficacy and accuracy than prior frameworks.

Moreover, the evaluation framework of FIG. 8 was also shown to produce scores with more differentiation between summarization models than other frameworks. Therefore, the embodiments herein perform better than prior frameworks with respect to this metric as well.

Notably, some of these other evaluation frameworks are largely focused on determining the overall semantic similarity between the original documents and the summaries. Or, the other evaluation frameworks hide entities in the summaries and try to predict how well these hidden entities can be predicted from the contents of the remaining entities. But neither consider whether the summaries can accurately answer queries from the original document, much less allow users to provide specific queries for the summaries to answer. Thus, the embodiments herein are able to focus on the information that is of most interest to users.

### IX. Example Operations

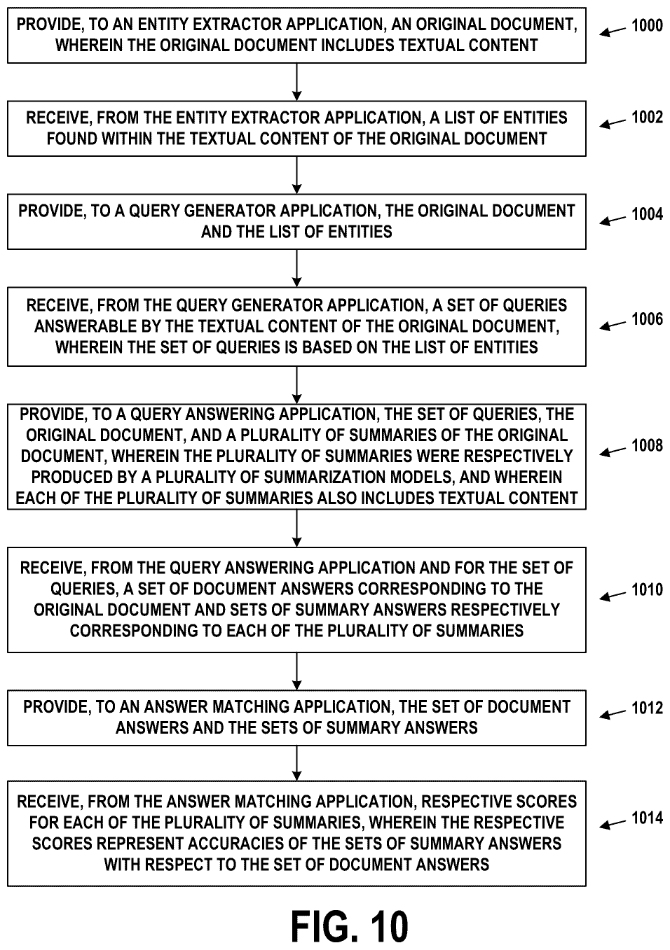

FIG. 10 is a flow chart illustrating an example embodiment. The process illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1000 may involve providing, to an entity extractor application, an original document, wherein the original document includes textual content.

Block 1002 may involve receiving, from the entity extractor application, a list of entities found within the textual content of the original document.

Block 1004 may involve providing, to a query generator application, the original document and the list of entities.

Block 1006 may involve receiving, from the query generator application, a set of queries answerable by the textual content of the original document, wherein the set of queries is based on the list of entities.

Block 1008 may involve providing, to a query answering application, the set of queries, the original document, and a plurality of summaries of the original document, wherein the plurality of summaries were respectively produced by a plurality of summarization models, and wherein each of the plurality of summaries also includes textual content.

Block 1010 may involve receiving, from the query answering application and for the set of queries, a set of document answers corresponding to the original document and sets of summary answers respectively corresponding to each of the plurality of summaries.

Block 1012 may involve providing, to an answer matching application, the set of document answers and the sets of summary answers.

Block 1014 may involve receiving, from the answer matching application, respective scores for each of the plurality of summaries, wherein the respective scores represent accuracies of the sets of summary answers with respect to the set of document answers.

Some embodiments may involve identifying a particular summarization model of the plurality of summarization models that produced a particular summary of the plurality of summaries that has a highest score out of all of the plurality of summaries; and selecting the particular summarization model to produce further summaries for a set of further original documents. Instead of the summarization model that produced the summary with the highest score, a summarization model that produced a summary with a score above a threshold value may be selected.

In some embodiments, at least some of the further original documents are knowledgebase articles, incidents, or email threads.

Some embodiments may involve (i) a second original document and (ii) a second plurality of summaries of the second original document respectively produced by the plurality of summarization models, wherein the second original document and each of the second plurality of summaries include textual content. These embodiments may further involve: providing, to the entity extractor application, the second original document; receiving, from the entity extractor application, a second list of entities found within the textual content of the second original document; providing, to the query generator application, the second original document and the second list of entities; receiving, from the query generator application, a second set of queries answerable by the textual content of the second original document, wherein the second set of queries is based on the second list of entities; providing, to the query answering application, the second set of queries, the second original document, and the second plurality of summaries; receiving, from the query answering application and for the second set of queries, a second set of document answers corresponding to the second original document and second sets of summary answers respectively corresponding to each of the second plurality of summaries; providing, to the answer matching application, the second set of document answers and the second sets of summary answers; receiving, from the answer matching application, second respective scores for each of the second plurality of summaries, wherein the second respective scores represent accuracies of the second sets of summary answers respect to the second set of document answers; and modifying the respective scores based on the second respective scores.

In some embodiments, at least some of the set of queries are provided by one or more human users.

In some embodiments, at least some of the set of queries are directed to a specific sub-topic within the textual content of the original document.

In some embodiments, the entity extractor application employs at least one of named entity recognition, regular expressions, or dependency parsing.

In some embodiments, the entities in the list of entities are words or phrases that are predicted to represent a semantic meaning of the original document.

In some embodiments, the query generator application employs at least one of a rule-based algorithm, an expert system, or an encoder-decoder neural network architecture.

In some embodiments, the query answering application employs sentiment analysis of the set of queries, the original document, and the plurality of summaries.

In some embodiments, the answer matching application determines, on a question-by-question basis, whether answers from each set of summary answers matches corresponding answers from the set of document answers.

In some embodiments, the respective scores are based on respective counts of matched answers between each set of summary answers and the set of document answers.

Some embodiments may involve: providing, to the entity extractor application, the plurality of summaries; receiving, from the entity extractor application, respective lists of further entities found within the textual content of the plurality of summaries; determining, for each of the respective lists of further entities, whether the entities therein are a subset of the list of entities; and modifying the respective scores based on extents to which the respective lists of further entities are subsets of the list of entities.

Some embodiments may involve: providing, to the query generator application, the respective lists of further entities; receiving, from the query generator application, sets of further queries respectively corresponding to each of the respective lists of further entities; providing, to the query answering application, the sets of further queries and the original document; receiving, from the query answering application and for the sets of further queries, sets of further answers respectively corresponding the sets of further queries; and further modifying the respective scores based on extents to which the sets of further answers were found in the original document.

### X. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing: (i) an original document, and (ii) a plurality of summaries of the original document respectively produced by a plurality of summarization models, wherein the original document and each of the plurality of summaries include textual content; and
one or more processors configured to:
provide, to an entity extractor application, the original document;
receive, from the entity extractor application, a list of entities found within the textual content of the original document;
provide, to a query generator application, the original document and the list of entities;
receive, from the query generator application, a set of queries answerable by the textual content of the original document, wherein the set of queries is based on the list of entities;
provide, to a query answering application, the set of queries, the original document, and the plurality of summaries;
receive, from the query answering application and for the set of queries, a set of document answers corresponding to the original document and sets of summary answers respectively corresponding to each of the plurality of summaries;
provide, to an answer matching application, the set of document answers and the sets of summary answers; and
receive, from the answer matching application, respective scores for each of the plurality of summaries, wherein the respective scores represent accuracies of the sets of summary answers with respect to the set of document answers.

2. The system of claim 1, wherein the one or more processors are further configured to:
identify a particular summarization model of the plurality of summarization models that produced a particular summary of the plurality of summaries that has a highest score out of all of the plurality of summaries; and
select the particular summarization model to produce further summaries for a set of further original documents.

3. The system of claim 2, wherein at least some of the further original documents are knowledgebase articles, incidents, or email threads.

4. The system of claim 1, wherein the persistent storage also contains: (i) a second original document, and (ii) a second plurality of summaries of the second original document respectively produced by the plurality of summarization models, wherein the second original document and each of the second plurality of summaries include textual content, and wherein the one or more processors are further configured to:
provide, to the entity extractor application, the second original document;
receive, from the entity extractor application, a second list of entities found within the textual content of the second original document;
provide, to the query generator application, the second original document and the second list of entities;
receive, from the query generator application, a second set of queries answerable by the textual content of the second original document, wherein the second set of queries is based on the second list of entities;
provide, to the query answering application, the second set of queries, the second original document, and the second plurality of summaries;
receive, from the query answering application and for the second set of queries, a second set of document answers corresponding to the second original document and second sets of summary answers respectively corresponding to each of the second plurality of summaries;
provide, to the answer matching application, the second set of document answers and the second sets of summary answers;
receive, from the answer matching application, second respective scores for each of the second plurality of summaries, wherein the second respective scores represent accuracies of the second sets of summary answers respect to the second set of document answers; and
modify the respective scores based on the second respective scores.

5. The system of claim 1, wherein at least some of the set of queries are provided by one or more human users.

6. The system of claim 1, wherein at least some of the set of queries are directed to a specific sub-topic within the textual content of the original document.

7. The system of claim 1, wherein the entity extractor application employs at least one of named entity recognition, regular expressions, or dependency parsing.

8. The system of claim 1, wherein the entities in the list of entities are words or phrases that are predicted to represent a semantic meaning of the original document.

9. The system of claim 1, wherein the query generator application employs at least one of a rule-based algorithm, an expert system, or an encoder-decoder neural network architecture.

10. The system of claim 1, wherein the query answering application employs sentiment analysis of the set of queries, the original document, and the plurality of summaries.

11. The system of claim 1, wherein the answer matching application determines, on a question by question basis, whether answers from each set of summary answers matches corresponding answers from the set of document answers.

12. The system of claim 11, wherein the respective scores are based on respective counts of matched answers between each set of summary answers and the set of document answers.

13. The system of claim 1, wherein the one or more processors are further configured to:
provide, to the entity extractor application, the plurality of summaries;
receive, from the entity extractor application, respective lists of further entities found within the textual content of the plurality of summaries;
determine, for each of the respective lists of further entities, whether the entities therein are a subset of the list of entities; and
modify the respective scores based on extents to which the respective lists of further entities are subsets of the list of entities.

14. The system of claim 13, wherein the one or more processors are further configured to:
provide, to the query generator application, the respective lists of further entities;
receive, from the query generator application, sets of further queries respectively corresponding to each of the respective lists of further entities;
provide, to the query answering application, the sets of further queries and the original document;
receive, from the query answering application and for the sets of further queries, sets of further answers respectively corresponding the sets of further queries; and
further modify the respective scores based on extents to which the sets of further answers were found in the original document.

15. A computer-implemented method comprising:
providing, to an entity extractor application, an original document, wherein the original document includes textual content;
receiving, from the entity extractor application, a list of entities found within the textual content of the original document;
providing, to a query generator application, the original document and the list of entities;
receiving, from the query generator application, a set of queries answerable by the textual content of the original document, wherein the set of queries are based on the list of entities;
providing, to a query answering application, the set of queries, the original document, and a plurality of summaries of the original document, wherein the plurality of summaries were respectively produced by a plurality of summarization models, and wherein each of the plurality of summaries also includes textual content;
receiving, from the query answering application and for the set of queries, a set of document answers corresponding to the original document and sets of summary answers respectively corresponding to each of the plurality of summaries;
providing, to an answer matching application, the set of document answers and the sets of summary answers; and
receiving, from the answer matching application, respective scores for each of the plurality of summaries, wherein the respective scores represent accuracies of the sets of summary answers with respect to the set of document answers.

16. The computer-implemented method of claim 15, further comprising:
identifying a particular summarization model of the plurality of summarization models that produced a particular summary of the plurality of summaries that has a highest score out of all of the plurality of summaries; and
selecting the particular summarization model to produce further summaries for a set of further original documents.

17. The computer-implemented method of claim 15, wherein at least some of the set of queries are provided by one or more human users.

18. The computer-implemented method of claim 15, further comprising:
providing, to the entity extractor application, the plurality of summaries;
receiving, from the entity extractor application, respective lists of further entities found within the textual content of the plurality of summaries;
determining, for each of the respective lists of further entities, whether the entities therein are a subset of the list of entities; and
modifying the respective scores based on extents to which the respective lists of further entities are subsets of the list of entities.

19. The computer-implemented method of claim 15, further comprising:
providing, to the query generator application, the respective lists of further entities;
receiving, from the query generator application, sets of further queries respectively corresponding to each of the respective lists of further entities;
providing, to the query answering application, the sets of further queries and the original document;
receiving, from the query answering application and for the sets of further queries, sets of further answers respectively corresponding the sets of further queries; and
further modifying the respective scores based on extents to which the sets of further answers were found in the original document.

20. An article of manufacture including a non-transitory computer-readable medium, having stored thereon program instructions that, upon execution by a computing system, cause the computing system to perform operations comprising:
providing, to an entity extractor application, an original document, wherein the original document includes textual content;
receiving, from the entity extractor application, a list of entities found within the textual content of the original document;
providing, to a query generator application, the original document and the list of entities;
receiving, from the query generator application, a set of queries answerable by the textual content of the original document, wherein the set of queries are based on the list of entities;
providing, to a query answering application, the set of queries, the original document, and a plurality of summaries of the original document, wherein the plurality of summaries were respectively produced by a plurality of summarization models, and wherein each of the plurality of summaries also includes textual content;
receiving, from the query answering application and for the set of queries, a set of document answers corresponding to the original document and sets of summary answers respectively corresponding to each of the plurality of summaries;
providing, to an answer matching application, the set of document answers and the sets of summary answers; and
receiving, from the answer matching application, respective scores for each of the plurality of summaries, wherein the respective scores represent accuracies of the sets of summary answers with respect to the set of document answers.
